(19) United States
(12) Patent Application Publication
(10) Pub. No.: US 2004/0250559 A1
(43) Pub. Date: Dec. 16, 2004

(54) Power out indicator

(76) Inventor: David M. Storms, Maryville, TN (US)

Correspondence Address: DAVID M. STORMS, 2108 LITTLE BEST RD., MARYVILLE, TN, 37803, US

(21) Appl. No.: 10/460,113

(22) Filed: Jun. 13, 2003

(51) Int. Cl. F25B 49/00; G01K 13/00

(52) U.S. Cl. 62/129; 62/125

(57) ABSTRACT

The Power Out Indicator can be engineered to utilize more than one source of energy such as a battery, solar cell, or any other source of energy for the purpose of recording numerical data. Refrigerators and Freezers on the market today have no way to notify the consumer how long they have been without power. The Indicator gives the consumer piece of mind that their perishables are safe to consume.

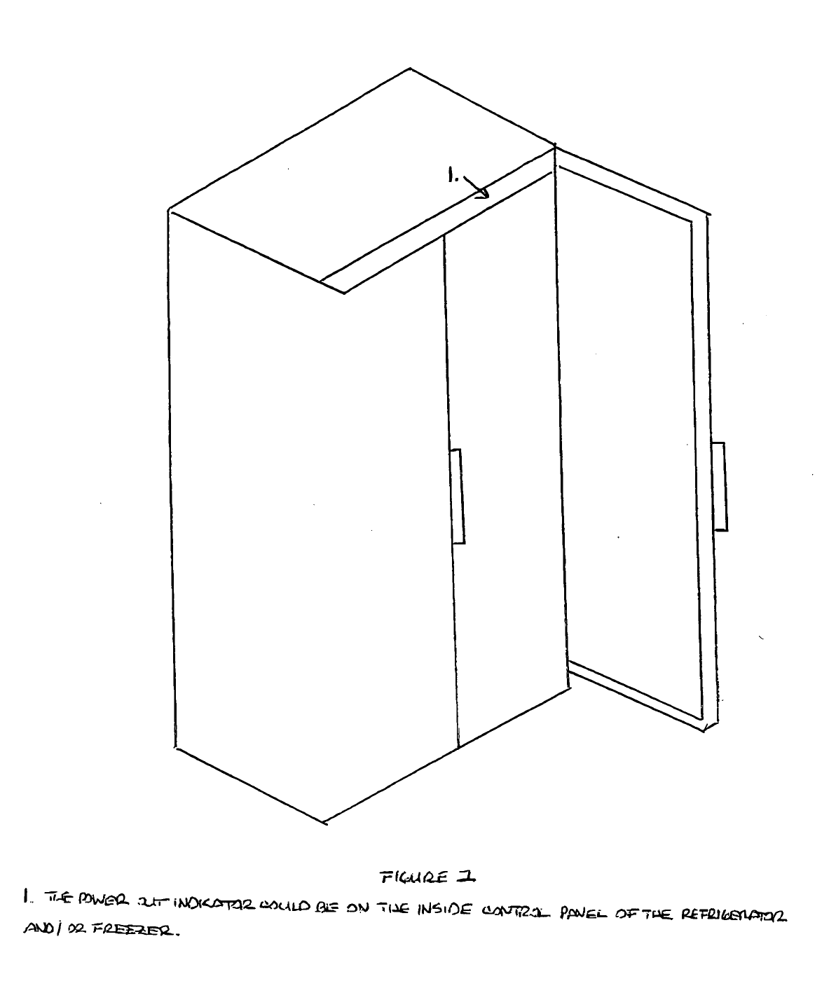

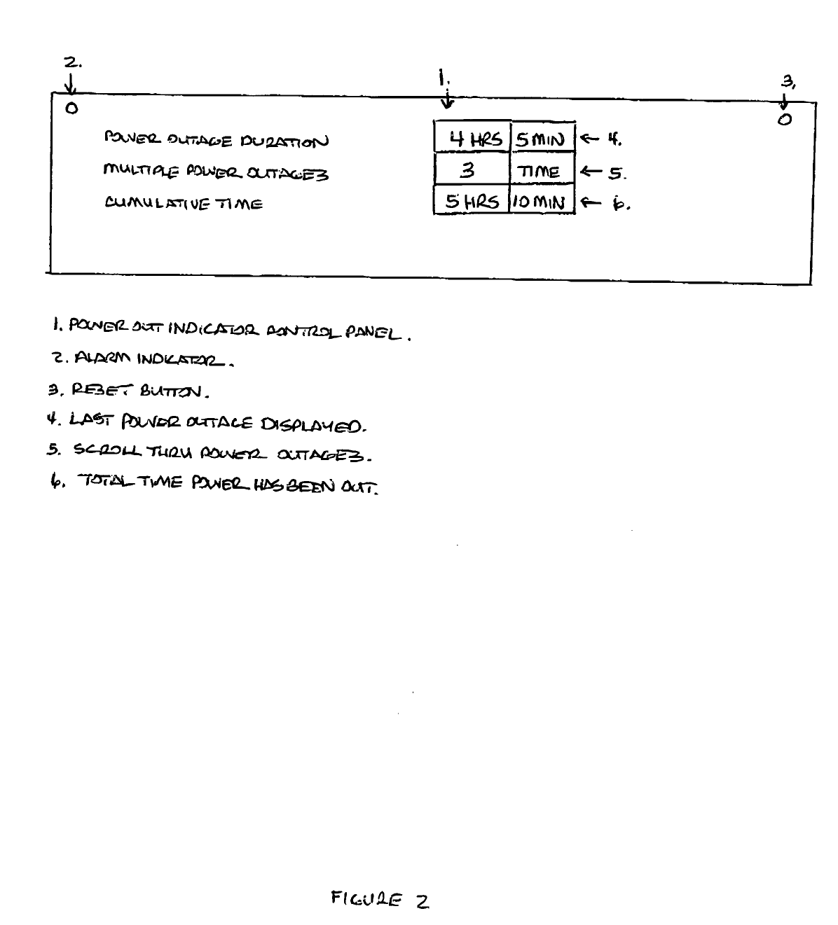

The Power Out Indicator is a component of a refrigerator or freezer that freezes and/or stores perishable foods and drinks for human consumption. The Power Out Indicator, hereafter, “Indicator,” will show the amount of time numerically a refrigerator and freezer, hereafter, “Appliances” have been out of power. The Indicator will be activated the second the appliances are without power. The Indicator can be engineered to utilize more than one source of energy to produce and record numerical data. The indicator could show multiple power outages as well. The Indicator could have an alarm that would sound or blink/flash indicating there has been a power outage. As previously mentioned, this indicator could have the capability to keep multiple power outages in chronological order displaying the amount of time for each power outage, hereafter, “Outage,” and then give a cumulative time the power was out. The Indicator will have the ability to be reset manually to erase the data from memory. The Indicator could be powered by a battery or any other energy source for the purpose of operating the Indicator.

### CROSS REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND OF THE INVENTION

The Indictor is for use on appliances that are used to store and preserve perishable foods and drinks. Appliances on the market today cannot notify the consumer of a power outage or of the amount of time the appliances were without power. The Indicator will inform the consumer of power outages and the duration which will give the consumer vital information as to whether the perishable items are safe to eat or drink.

### BRIEF SUMMARY OF THE INVENTION

The Indicator will allow the consumer to safely consume their perishable items housed by their appliances without being concerned about eating or drinking contaminated perishables. Appliances on the market today cannot in any way notify the consumer of the amount of time they have been without power. The potential result is the consumer getting food poisoning by food that has thawed and then refrozen or perishables that have not been maintained at an appropriate temperature.

### DETAILED DESCRIPTION OF THE INVENTION

The Power Out Indicator is a component of a refrigerator or freezer that freezes and/or stores perishable foods and drinks for human consumption. The Power Out Indicator, hereafter, “Indicator,” will show the amount of time numerically a refrigerator and freer, hereafter, “Appliances,” have been out of power. The indicator will be activated the second the appliances are without power. The indicator can be engineered to utilize more than one source of energy to produce and record numerical data. The Indicator could show multiple power outages as well. The indicator could have an alarm that would sound or blink/flash indicating there has been a power outage. As previously mentioned, this indicator could have the capability to keep multiple power outages in chronological order displaying the amount of time for each power outage, hereafter, “Outage,” and then give a cumulative time the power was out. The Indicator will have the ability to be reset manually to erase the data from memory. The Indicator could be powered by a battery or any other energy source for the purpose of operating the Indicator. The Indicator will allow the consumer to safely consume their perishable items housed by their appliances without being concerned about eating or drinking contaminated perishables. Appliances on the market today cannot in any way notify the consumer of the amount of time they have been without power. The potential result is the consumer getting food poisoning by food that has thawed and then been refrozen or perishables that have not been maintained at an appropriate temperature.

1. What I claim as my invention is the Power Out Indicator which is a component of a refrigerator or freezer that freezes and/or stores perishable foods and drink for human consumption.

2. What I claim as my invention is the Power Out Indicator that will show the amount of time numerically a refrigerator and freezer have been out of power.

3. What I claim as my invention is the Power Out Indicator which can be powered by a battery, solar cell, or any other energy source for the purpose of tracking power outages numerically to ensure the safe consumption of perishables for all consumers who have freezers or refrigerators.
